(19) United States
(12) Patent Application Publication
(10) Pub. No.: US 2002/0026300 A1
(43) Pub. Date: Feb. 28, 2002

(54) Design chart, an apparatus for displaying the design chart and a method for generating the design chart

(76) Inventor: Mutsumi Shimazaki, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/828,227

(22) Filed: Apr. 9, 2001

(30) Foreign Application Priority Data
Aug. 28, 2000 (JP) 2000-257652

(51) Int. Cl. G06F 17/10

(52) U.S. Cl. 703/2

(57) ABSTRACT

As a design chart for a high frequency circuit, a composite chart in which scale grid lines of polar coordinates are drawn on a Smith chart so that a center (an origin) of the Smith chart becomes an origin of the scale grid lines of the polar coordinates is used. Or, a composite chart in which scale grid lines of orthogonal coordinates are drawn on a Smith chart so that a center (an origin) of the Smith chart becomes an origin of the scale grid lines of the orthogonal coordinates is used. The composite charts are drawn by an apparatus for displaying the design chart which includes a first display unit for displaying the Smith chart and a second display unit for displaying the scale grid lines of one of the polar coordinates and the orthogonal coordinates on the Smith chart.

### BACKGROUND OF THE INVENTION

1. Field of the Invention

This invention relates to a design chart for a circuit with a high frequency, an apparatus for displaying the design chart and a method for generating the design chart.

2. Description of the Related Art

In designing a circuit with a high frequency, a Smith chart and an admittance chart are used as design charts for visually calculating reflection transmission characteristics of a transmission line and compatibility between circuits.

FIG. 8 illustrates an example of the Smith chart. In the Smith chart, an impedance plane Z=R+jX is projected on a reflection-transmission coefficient Γ plane. In the admittance chart, an admittance plane Y=G+jB is projected on a reflection-transmission coefficient Γ plane. Complex impedance R and X can be read from the Smith chart, and a reflection 20 transmission coefficient Γ can be obtained in the Smith chart. Similarly, complex impedance G and B can be read from the admittance chart, and a reflection-transmission coefficient Γ can be obtained in the admittance chart.

### SUMMARY OF THE INVENTION

In case that a user tries to obtain a value of a reflection-transmission coefficient Γ=m<θ of a polar coordinate in the Smith chart or admittance chart, the user measures a distance of the coordinate from a center with a ruler, calculates a value of m based on a scale ratio, and measures an angle θ with a protractor. When the user tries to obtain a value of a reflection transmission coefficient Γ=p+jq of an orthogonal coordinate, the user measures a distance of the coordinate from a center axis with a ruler, and obtains a value of p by scaling. Similarly, the user also measures a distance of the coordinate from an additional line vertical to the center axis, and obtains a value of q by scaling. A value of a complex impedance and a complex admittance can be obtained from the reflection-transmission coefficient Γ by performing a reverse operation.

In some Smith chart and admittance chart, scales of angles θ of polar coordinates are provided on an outer circumference of the chart, and scales of orthogonal coordinates p are provided at a bottom of the chart for reducing such work, e.g., measuring the distance with the ruler and scaling or measuring e with the protractor. In such Smith chart and admittance chart, values of θ and p can be read immediately only by placing a straight ruler on the chart. However, a tool still has to be used, and the values of m and q have to be obtained by measuring with the ruler and scaling.

It is one of the objects of this invention to provide a design chart in which the reflection-transmission coefficient Γ in the polar coordinates and orthogonal coordinates can be immediately read in the Smith chart and admittance chart.

It is another object of this invention to provide an apparatus for displaying the design chart and a method for generating the design chart in which the reflection-transmission coefficient Γ in the polar coordinates and orthogonal coordinates can be immediately read in the Smith chart and admittance chart.

According to an aspect of this invention, a design chart, characterized in that scale grid lines of one of polar coordinates and orthogonal coordinates are drawn on a Smith chart, is provided.

According to another aspect of this invention, an apparatus for displaying a design chart including a first display unit for displaying a Smith chart and a second display unit for displaying scale grid lines of one of polar coordinates and orthogonal coordinates on the displayed Smith chart is provided.

According to another aspect of this invention, a method for generating a design chart including generating a Smith chart, and generating scale grid lines of one of polar coordinates and orthogonal coordinates on the generated Smith chart is provided.

Further features and applications of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Other objects features, and advantages of the invention will be apparent from the following description when taken in conjunction with the accompany drawings.

### BRIEF DESCRIPTION OF THE DRAWINGS

FIG. 1 illustrates an example of a composite chart in which scale grid lines in polar coordinates are drawn on a Smith chart in Embodiment 1;

FIG. 2 illustrates an example of a composite chart in which scale grid lines in orthogonal coordinates are drawn on a Smith chart in Embodiment 1;

FIG. 3 illustrates an configuration of an apparatus for displaying the design chart;

FIG. 4 shows a flow chart of a display procedure by the apparatus for displaying the design chart;

FIG. 5 shows a flow chart of a redisplay processing operation in a data processor 1;

FIG. 6 shows a flow chart of an operation in case that the apparatus for displaying the design chart according to Embodiment 1 is applied to a computer or a meter;

FIG. 7 shows a flow chart of a display procedure by the apparatus for displaying the design chart in Embodiment 3; and

FIG. 8 illustrates an example of a Smith chart according to the related art.

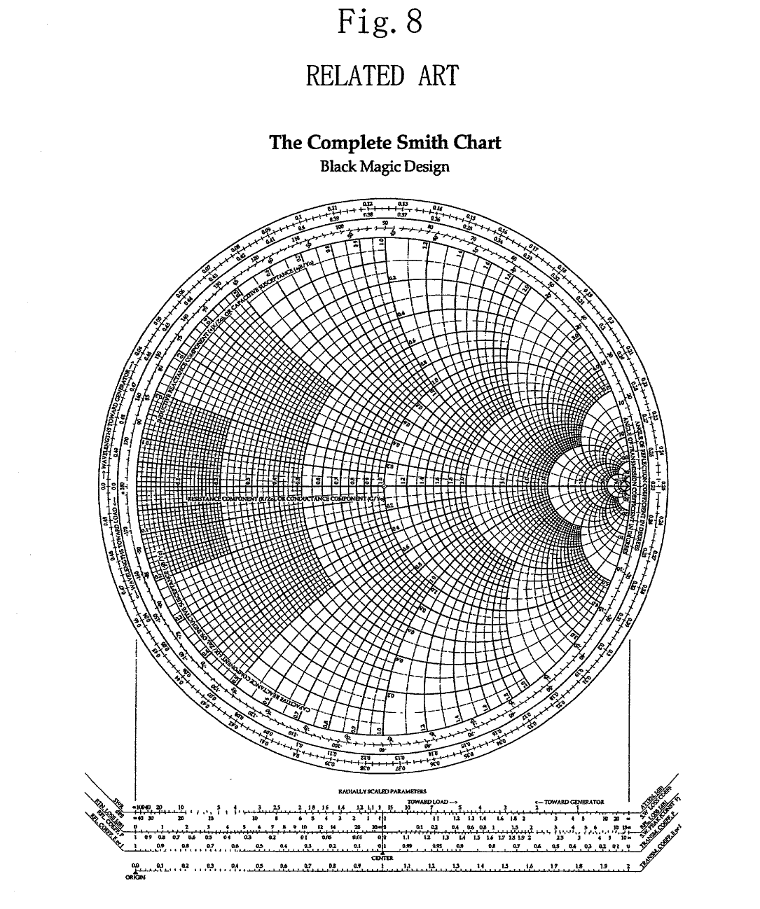

### DETAILED DESCRIPTION OF THE PREFERRED EMBODIMENTS

Embodiment 1.

Explanations are made on an embodiment of this invention.

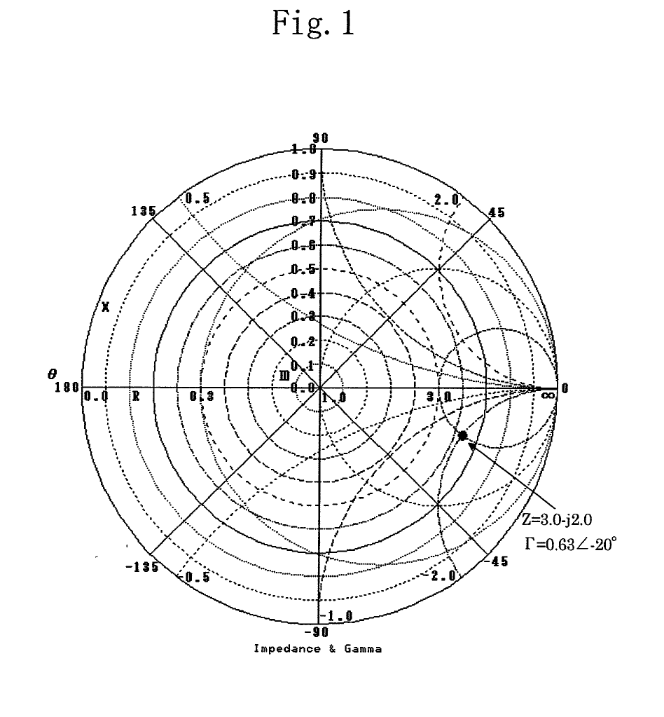

FIG. 1 illustrates an example of the design chart in Embodiment 1. FIG. 1 is a composite chart of an impedance and polar coordinates Γ=m<θ, in which scale grid lines of the polar coordinates are drawn on a Smith chart.

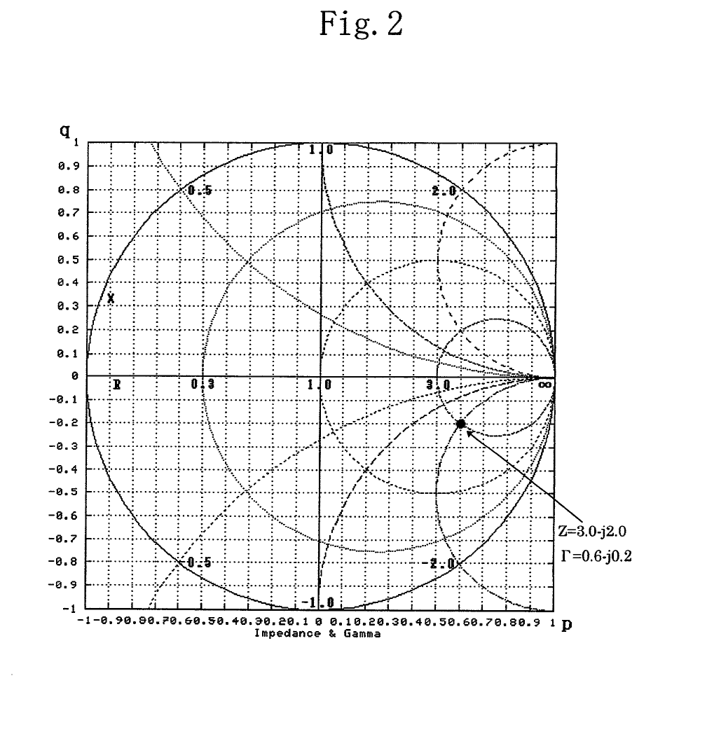

FIG. 2 illustrates another example of the design chart in Embodiment 1. FIG. 2 is a composite chart of an impedance and orthogonal coordinates Γ=p+jq, in which scale grid lines of the orthogonal coordinates are drawn on a Smith chart.

Hereinafter, in this specification, either the design chart in which the scale grid lines of the polar coordinates are drawn on the Smith chart or the design chart in which the scale grid lines of the orthogonal coordinates are drawn on the Smith chart is called as the composite chart. Further, design charts include the Smith chart, the admittance chart, and the above composite chart. The scale grid lines include either one or both of the scale grid lines of the polar coordinates and the scale grid lines of the orthogonal coordinates unless otherwise specified.

In the composite chart of the impedance and the polar coordinates Γ=m<e, the scale grid lines of the polar coordinates of Γ including circular distance lines with a constant m from a center (an origin) of the Smith chart and radial angle lines with a constant θ from the center of the Smith chart are drawn on the Smith chart. The composite chart is drawn so that the origin m=0 of scale grids is matched with the center R=1.0, X=0 of the Smith chart, and a standard θ=0° of the angle lines is matched with a line X=0.

In the composite chart of the impedance and the orthogonal coordinates Γ=p+jq, scale grid lines of the orthogonal coordinates of Γ including interval lines with a constant p from the center (origin) of the Smith chart and interval lines with a constant q from the center (origin) of the Smith chart are drawn on the Smith chart. The composite chart is drawn so that the origin p=0, q=0 of scale grids is matched with the center R=1.0, X=0 of the Smith chart. In other words, the composite chart is drawn so that the origin of the scale grid lines is placed at the center of the Smith chart.

In this specification, the design chart includes a design chart form (blank form) without data and a design chart form with data. Further, the design chart also includes (design) chart format.

The above method for generating the composite chart can be applied to a case of using the admittance chart instead of the Smith chart.

The drawn composite charts are printed on paper and used as graphic paper.

It is also possible to print the drawn composite charts on clear sheets. The clear sheets can be overlaid on the Smith chart or admittance chart. A user overlays the clear sheet, on which the composite chart is drawn, on the Smith chart or admittance chart.

Further, it is also possible to extract the scale grid lines (scale grid lines of Γ) from the composite chart. is The scale grid lines are printed on a clear sheet. The scale grid lines are printed on the clear sheet to match with a scale of the Smith chart or admittance chart.

By overlaying the clear sheet, on which the scale grid lines are printed, on paper with the Smith chart or admittance chart according to the related art, the reflection-transmission coefficient Γ can be read without scaling.

Further, the clear sheet on which the scale grid lines are printed can be also used by sticking to a display device of a computer or meter. The clear sheet, on which the scale grid lines are printed, is overlaid on the Smith chart or admittance chart and stuck to the display device.

With reference to drawings, explanations are made on an embodiment of using the composite chart in the computer or meter.

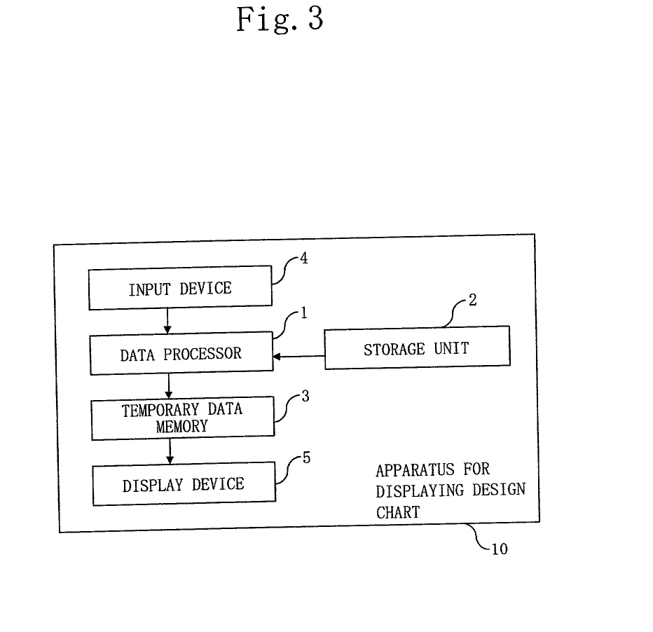

FIG. 3 illustrates a configuration of an apparatus 10 for displaying a design chart.

The apparatus 10 for displaying the design chart generates a composite chart, and displays the generated composite chart. The apparatus 10 for displaying the design chart is realized by using functions provided in the computer, meter, etc.

The apparatus 10 for displaying the design chart as illustrated in FIG. 3 includes a data processor 1, a storage unit 2, a temporary data memory 3, an input device 4, and a display device 5.

The data processor 1, e.g., CPU (Central Processing Unit), etc. performs data processing. In this embodiment, the data processor 1 generates (or produces or forms) screen data for displaying image data in the display device by using a setting parameter (explained later) stored in the storage unit 2.

The screen data include the Smith chart, admittance chart, scale grid lines of the orthogonal coordinates, and scale grid lines of the polar coordinates.

The storage unit 2, e.g., nonvolatile storage medium such as ROM (Read Only Memory), HDD (Hard Disk Drive), etc. stores data. In this embodiment, the storage unit 2 stores the setting parameter.

The setting parameter includes a chart parameter for generating image data for displaying one of the Smith chart and admittance chart and a parameter of scale grid lines for generating the scale grid lines.

The parameter of the scale grid lines specifies intervals of the grids, display size, display area, etc. of the scale grid lines.

The storage unit 2 stores a default value as the setting parameter. The default value can be modified by the user by using the input device 4.

The temporary data memory 3, (e.g., a cache memory, etc.) stores the data temporarily. In this embodiment, the temporary data memory 3 stores the screen data generated by the data processor 1 temporarily.

The input device 4 is a device, (e.g., a keyboard, mouse, etc.) for inputting the data. The user inputs the data, e.g., the setting parameter, etc. by using the input device 4.

The display device 5 is a device, e.g., CRT (Cathode-Ray Tube) unit, etc. for displaying the data. The display device 5 displays the screen data generated by the data processor 1.

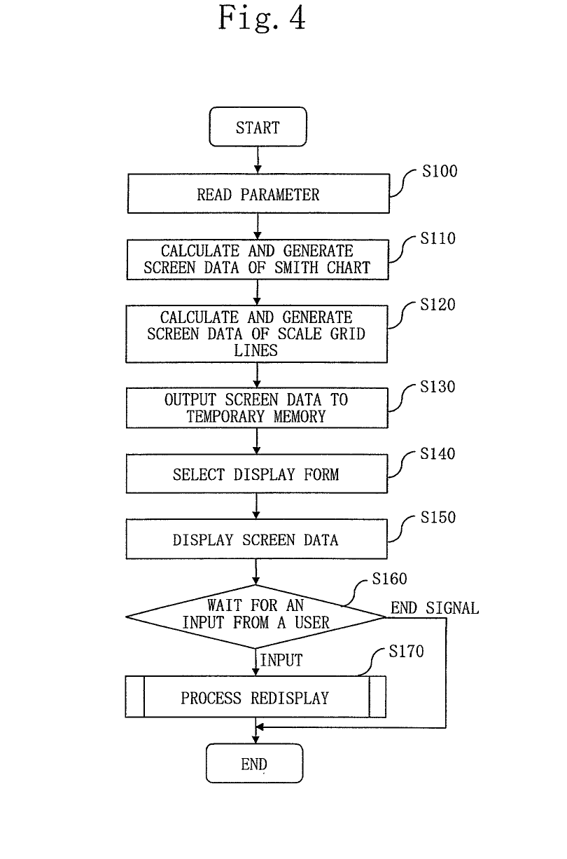

With reference to FIG. 4, explanations are made on a display procedure of the apparatus 10 for displaying the design chart.

FIG. 4 shows a flow chart of the display procedure of the apparatus 10 for displaying the design chart.

At first, the data processor 1 reads the setting parameter from the storage unit 2 (step S100). Then, the data processor 1 obtains a chart parameter and a parameter of the scale grid lines from the setting parameter which has been read. The data processor 1 generates screen data of the Smith chart (or, admittance chart. Hereinafter, explanations are made by using the Smith chart.) by calculating based on the chart parameter (step S110).

Then, the data processor 1 generates screen data of the scale grid lines of the polar coordinates and the scale grid lines of the orthogonal coordinates by using the parameter of the scale grid lines (step S120). The above scale grid lines are generated so that the center of the Smith chart becomes the origin. The screen data of either one or both of the scale grid lines of the polar coordinates and the scale grid lines of the orthogonal coordinates can be generated. The generating screen data are acceptable as far as the data correspond to a display form which can be selected by the user.

The screen data generated in steps S110 and S120 are output to the temporary data memory 3 (step S130).

In this case, if each of the screen data are stored in the storage unit 2 in advance, the data processor 1 only needs to read the screen data from the storage unit 2 and output the screen data to the temporary data memory 3.

The user selects a display form, and inputs the selected display form through the input device 4.

The display form specifies if only the Smith chart is displayed, or the composite chart of the Smith chart and the scale grid lines (in one of the polar coordinates and the orthogonal coordinates) is displayed. Further, in some cases, the display form specifies to display the admittance chart instead of the Smith chart.

The data processor 1 obtains the display form input by the user by using the input device (Step S140).

The data processor 1 reads the screen data from the temporary data memory 3 based on the obtained display form. For example, if the display form specifies to display only the Smith chart, the data processor 1 reads the screen data of the Smith chart. If the display form specifies to display the Smith chart and the scale grid lines of the polar coordinates, the data processor 1 reads the screen data of the Smith chart and the scale grid lines of the polar coordinates.

The data processor 1 outputs the read screen data to the display device 5 (step S150). The data processor 1 displays the Smith chart, detects a center of the Smith chart, and displays the scale grid lines of the polar coordinates so that the origin of the scale grid lines is displayed (placed) at the detected center.

In this way, the design chart is displayed. Consequently, the composite chart of the impedance and the reflection-transmission coefficient is displayed.

The user can also modify the displaying design chart by inputting determined data (step S160).

For example, in case that intervals of the scale grid lines on the Smith chart, display area of the design chart, etc. are to be modified, the user inputs the setting parameter corresponding to the modification as the determined data. In case that the display form is to be changed, the user inputs a display form as the determined data. The determined data can be any other data as far as the data are predefined as data to be input by the user.

When the determined data are input by the user (input in step S160), the data processor 1 performs redisplay processing (step S170).

In case that an end signal is input by the user (end signal in step S160), the data processor 1 ends processing.

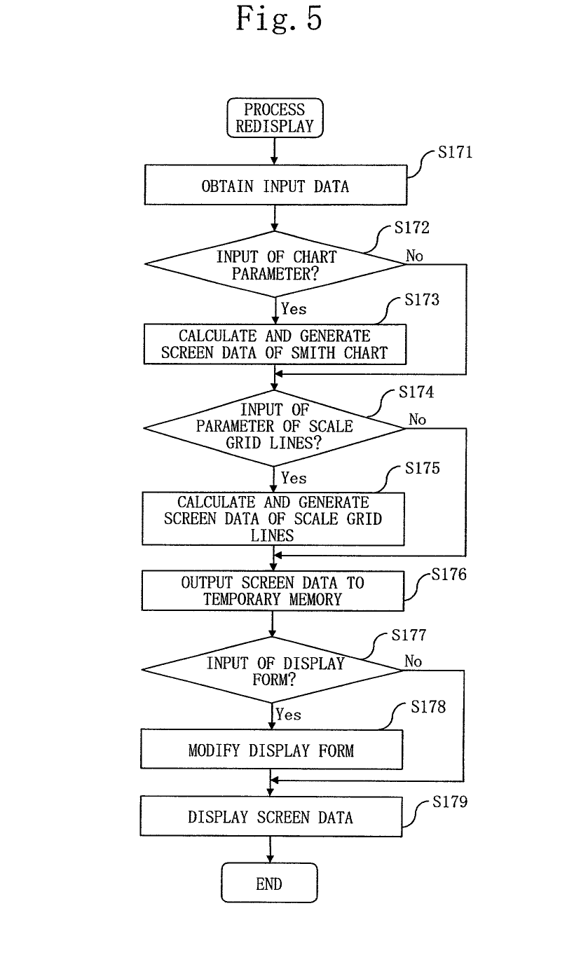

With reference to FIG. 5, operations of redisplay processing are explained.

The data processor 1 receives the determined data input by the user through the input device 4.

The data processor 1 obtains the data input by the user. The data processor 1 obtains information, e.g., a setting parameter (e.g., a chart parameter, a parameter of scale grid lines), display form, etc. (step S171).

In case that the chart parameter is input (Yes in step S172), the data processor 1 generates the screen data of the Smith chart by calculating based on the input chart parameter (step S173).

In case that the parameter of the scale grid lines is input (Yes in step S174), the data processor 1 generates the screen data of the scale grid lines of the polar coordinates and the scale grid lines of the orthogonal coordinates by calculating based on the input chart parameter (step S175). The origin of the scale grid lines of the polar coordinates and the scale grid lines of the orthogonal coordinates is same as the origin of the Smith chart. The screen data corresponding to the display form are generated as in step S120 in FIG. 4.

The data processor 1 stores the screen data generated in steps S173 and S174 in the temporary data memory 3 (step S176).

In case that the display form is input (Yes in step S177), the data processor 1 changes the display form to the input display form (step S178).

At the end, the data processor 1 displays the screen data stored in the temporary data memory 3 in the display device 5 (step S179).

The operations of redisplay processing (steps S170, S171-S179) are repeated in case that the determined data (e.g., a setting parameter, a display form) are input by the user.

An example of the setting parameter input by the user is illustrated in the following.

In the Smith chart or admittance chart, the user inputs the chart parameter for designating the display area.

For the scale grid lines of the polar coordinates, the user inputs the parameter of the scale grid lines specifying angles of radial lines and intervals of concentric circles. For the scale grid lines of the orthogonal coordinates, the user inputs the parameter of the scale grid lines specifying intervals of the grid lines.

By inputting such parameters, the user can display the desired design chart including the composite chart in the display device 5.

In the above display procedure, the Smith chart is used as an example. However, the admittance chart can be used instead of the Smith chart to display the design chart in the same display procedure.

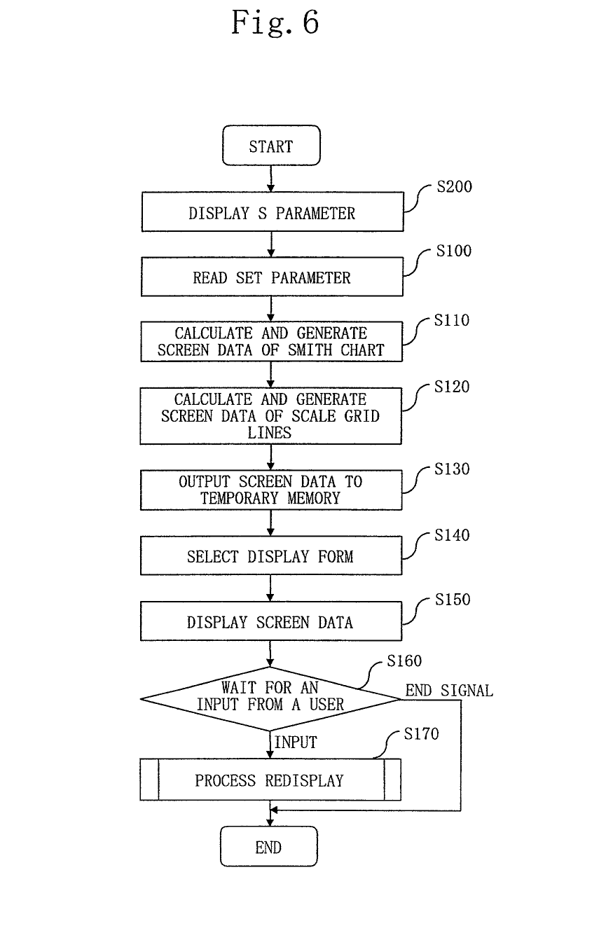

The composite chart can be used in the computer and meter as stated in the following. An example of the operations are shown in FIG. 6. It is assumed that the computer and meter has the data display function of the Smith chart and admittance chart.

In the computer and meter, a S (Scattering) parameter data obtained by calculating and measuring are displayed in the display device 5 (step S200). Therefore, the composite chart is displayed in the display device 5 by overlaying on the S parameter as above method (steps S100-S170). In this way, the design chart in which the impedance of the S parameter data and the reflection-transmission coefficient can be read at the same time can be displayed in the computer and meter.

The composite chart which is drawn in this way can be applied to arbitrary S parameter data.

Explanations are made on a case of obtaining the reflection transmission coefficient Γ with the complex impedance Z=3.0−j20 plot on the Smith chart. When the user uses FIG. 1, the user reads m=0.63 from the constant distance line of the polar coordinate scale and θ=−20° from the angle line, and obtains that Γ=0.63<−20°. When the user uses FIG. 2, the user reads p=0.6 and q=−0.2 from the interval line of the orthogonal coordinate scale, and obtains that Γ=0.6−j0.2.

According to the design chart of the impedance and the reflection-transmission coefficient, the apparatus for displaying the design chart, and the method for generating the design chart of this invention, the figures of the complex impedance or complex admittance can be converted into the figures of the reflection-transmission coefficient Γ of the polar or orthogonal coordinates without measuring with the ruler and scaling.

Besides converting figures of the impedance into the reflection transmission coefficient Γ, this invention can help designers of circuits who are not familiar with the Smith chart and admittance chart to understand concept of a S parameter.

This invention can also provide the design chart which can cope with arbitrary data form in an input and output data system of the complex impedance or complex admittance calculating setting parameter by the computer and the meter, and the reflection-transmission coefficient r of the polar or orthogonal coordinates.

Embodiment 2.

In Embodiment 1, explanations are made on the case of storing a setting parameter of a default value in the storage unit 2. The storage unit 2 can also store a plurality of setting parameters.

For example, the apparatus 10 for displaying the design chart predefines the setting parameter of the default value among the plurality of the setting parameters.

The apparatus 10 for displaying (or drawing) the design chart also predefines choices for indicating each of the setting parameters. The user inputs one of the choices for selecting a setting parameter.

With reference to FIGS. 4 and 5, operations of Embodiment 2 are explained.

The data processor 1 performs processing of steps S100-S150 in FIG. 4 by using the above setting parameter of the default value, and displays the design chart.

In step S150, when the data processor 1 displays the screen data, the data processor 1 also displays an input screen for requesting the user to select the setting parameter.

The data processor 1 displays the plurality of the setting parameters stored in the storage unit 2 and the choices corresponding to the plurality of the setting parameters in the input screen, and requests the user to select a setting parameter (one of the choices) from the displayed plurality of the setting parameters.

The data processor 1 asks the user to select a display form or a setting parameter from the plurality of the setting parameters and to input selected data through the display device 5 and input device 4 (step S160).

The data processor 1 performs redisplay processing by using data input by the user (step S170).

In step S171, in case that the input data are the choice of the above setting parameter, the data processor 1 reads the setting parameter corresponding to the choice from the storage unit 2.

In case that other determined data are input, operations are same as in Embodiment 1.

In selecting the setting parameter, it is possible to select the chart parameter and the parameter of the scale grid lines separately.

The data processor 1 obtains the setting parameter selected by the user through the input device 4. The data processor 1 displays the design chart in the display device 5 based on the obtained setting parameter by performing the processing of steps S110-S150.

In the above processing, the data processor 1 receives the input of the choice of the above setting parameter from the user in step S160. However, it is also possible that the data processor 1 receives the setting parameter from the user before displaying the design chart of the default value.

According to the apparatus for displaying the design chart of this invention, the design chart which is desired by the user can be displayed by receiving the determined data input by the user.

Embodiment 3.

In Embodiment 1, explanations are made on a case of generating the screen data by calculating based on the setting parameter in steps S110 and S120.

In Embodiment 3, explanations are made on a case of storing the screen data generated by the data processor 1 by calculating based on an arbitrary setting parameter (default value).

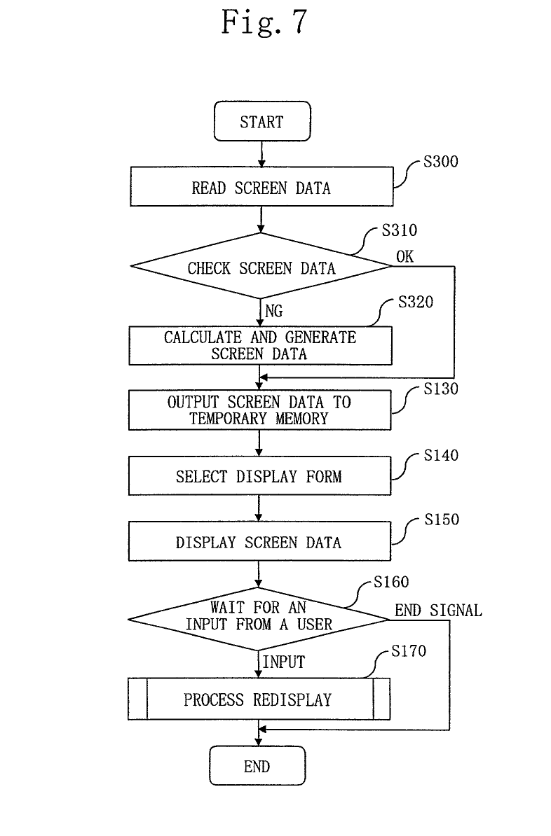

FIG. 7 illustrates an example of operations in Embodiment 3.

The data processor 1 reads the screen data from the storage unit 2 (step S300).

The data processor 1 checks if there are all the screen data for displaying (step S310).

If there are all the screen data (OK in step S310), the data processor 1 performs processing of steps S130-S150 as in Embodiment 1, and displays the design chart.

Operations in case that the user inputs the determined data in step S160 are same as the operations explained in Embodiments 1 and 2.

The storage unit 2 may store either all or some of the Smith chart, admittance chart, scale grid lines of the polar coordinates, and scale grid lines of the orthogonal coordinates as the screen data.

In case that some or all of the screen data for displaying are not stored in the storage unit 2 (NG in step S310), the data processor 1 performs processing of step S110 or S120 as in Embodiment 1, and generates the screen data (step S320). The data processor 1 performs the processing of steps S130-S150 by using the generated screen data, and displays the design chart.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only and is limited only as defined in the following claims and the equivalents thereto.

What is claimed is:

1. A design chart, characterized in that scale grid lines of one of polar coordinates and orthogonal coordinates are drawn on a Smith chart.

2. The design chart of claim 1, wherein the Smith chart has a center, the scale grid lines have an origin, and the origin of the scale grid lines is placed at the center of the Smith chart.

3. The design chart of claim 1, wherein an admittance chart is used instead of the Smith chart.

4. The design chart of claim 1, wherein the scale grid lines drawn on the Smith chart are the scale grid lines of the polar coordinates, wherein the scale grid lines of the polar coordinates include a plurality of circular distance lines drawn with a constant interval from a center of the Smith chart and a plurality of radial angle lines with a constant angle from the center of the Smith chart.

5. The design chart of claim 1, wherein the scale grid lines drawn on the Smith chart are the scale grid lines of the orthogonal coordinates, wherein the scale grid lines of the orthogonal coordinates include a plurality of vertical lines drawn with a constant interval from a center of the Smith chart and a plurality of horizontal lines drawn with a constant interval from the center of the Smith chart.

6. An apparatus for displaying a design chart comprising:
a first display unit for displaying a Smith chart; and
a second display unit for displaying scale grid lines of one of polar coordinates and orthogonal coordinates on the displayed Smith chart.

7. The apparatus for displaying the design chart of claim 6, wherein the second display unit detects the center of the Smith chart and displays the scale grid lines so that the origin of the scale grid lines is displayed at the detected center.

8. The apparatus for displaying the design chart of claim 6, further comprising a storage area for storing data for drawing the Smith chart, wherein the first display unit reads the data for drawing the Smith chart from the storage area, and displays the Smith chart based on the read data for drawing the Smith chart.

9. The apparatus for displaying the design chart of claim 8, wherein the storage area stores the data for drawing the scale grid lines including at least one of the polar coordinates and the orthogonal coordinates, wherein the second display unit reads the data for drawing the scale grid lines from the storage area, and displays the scale grid lines on the Smith chart based on the read data for drawing the scale grid lines.

10. The apparatus for displaying the design chart of claim 9, wherein the storage area stores the data for drawing a plurality of sets of scale grid lines including the polar coordinates and the orthogonal coordinates, wherein the second display unit selects one of the scale grid lines from the plurality of the scale grid lines, reads the data for drawing the selected scale grid lines from the storage area, and displays the scale grid lines on the Smith chart based on the read data for drawing the scale grid lines.

11. The apparatus for displaying the design chart of claim 6, wherein the second display unit inputs a parameter for specifying a size of the scale grid lines, calculates the size of the scale grid lines based on the input parameter, and displays the scale grid lines based on the calculated size.

12. The apparatus for displaying the design chart of claim 6, wherein the first display unit displays an admittance chart instead of the Smith chart.

13. A method for generating a design chart comprising:
generating a Smith chart; and
generating scale grid lines of one of polar coordinates and orthogonal coordinates on the generated Smith chart.

14. The design chart of claim 1 which is generated by a first mechanism for generating the Smith chart and a second mechanism for detecting a center of the Smith chart and generating the scale grid lines so that an origin of the scale grid lines is placed at the detected center.

15. The design chart of claim 1 which is drawn by an apparatus for displaying the design chart including a first display unit for displaying the Smith chart and a second display unit for displaying the scale grid lines of one of polar coordinates and orthogonal coordinates on the Smith chart.
